(19) United States
(12) Patent Application Publication
(10) Pub. No.: US 2014/0314212 A1
(43) Pub. Date: Oct. 23, 2014

(54) PROVIDING ADVISORY INFORMATION ASSOCIATED WITH DETECTED AUDITORY AND VISUAL SIGNS IN A PSAP ENVIRONMENT

(71) Applicant: AVAYA INC., Basking Ridge, NJ (US)

(72) Inventors: Jon Bentley, New Providence, NJ (US); Paul Roller Michaelis, Louisville, CO (US); Mark Fletcher, Ringwood, NJ (US)

(21) Appl. No.: 13/867,769

(22) Filed: Apr. 22, 2013

(51) Int. Cl. H04M 3/51

(52) U.S. Cl. CPC H04M 3/5116
USPC 379/38

(57) ABSTRACT

A Public Safety Answering Point (PSAP) is configured to enable the detection of one or more clinical signs associated with a caller. The clinical signs may include both auditory and visual clinical signs and may be detected by analyzing a portion of the call information to determine one or more characteristics associated with the call information and comparing the one or more determined characteristics to known clinical sign characteristics. The PSAP may additionally or alternatively utilize the detection of the clinical signs to assist and/or provide an advisory recommendation in the decision of which, if any first responder resources should be dispatched; the recommendation may include which resources and at what priority the resources should be dispatched.

### FIELD OF THE DISCLOSURE

An exemplary embodiment is generally directed toward detecting auditory and visual clinical signs within a Public Safety Answering Point (PSAP) or E911 contact center.

### BACKGROUND

Contact centers are often used to direct customer escalations (e.g., contacts) to various contact center resources (e.g., agents) based on a determination of the customer's question(s), the customer's needs, the availability of agents, the skills of agents, and so on. One specific type of contact center is known as a Public Safety Answering Point (PSAP) or E911 contact center.

PSAPs experience many unique problems not often encountered in a traditional contact center, usually because each contact in a PSAP is associated with an emergency. One problem that is more commonly experienced by PSAPs as compared to traditional contact centers relates to dispatching resources in cases of emergencies; specific resources, such as Advanced Life Support or Basic Life Support, are often dispatched to an emergency based on the information provided by a patient or caller—such as a witness and/or bystander. In cases where the patient, or caller, is properly alert and oriented and can tell the dispatcher reasonably what they need or what the problem is, the decision by the call-taker or dispatcher is relatively easy. In cases where there is a sick or injured person, if the patient or victim is unable or unwilling to communicate, or the patient is struggling in some way, it is often unclear if they would be better served with an ALS or BLS unit.

In such situations, how can a PSAP call-taker or dispatcher quickly learn the true nature of an emergency? That is, how can he or she best determine whether a patient would be better served with an Advanced Life Support (ALS) or a Basic Life Support (BLS) unit? In many cases, the PSAP call-taker may make a subjective decision based on what they hear or that which is communicated to them by the patient, or caller, to determine an appropriate response level to an emergency. Many times, the PSAP call-taker will not be aware of nor have the medical training to know the significance of clinical signs and/or indicators that may be presented to them. Dispatching the correct resources could be the difference between life and death in serious cases.

### SUMMARY

It is with respect to the above issues and other problems that the embodiments presented herein were contemplated. This disclosure proposes, among other things, the ability to allow a dispatcher to invoke a clinical signs assessment module at their work station and, during their interaction with a patient, and/or caller, determine appropriate resources to dispatch in order to treat the patient based on one or more clinical signs that are presented by the patient. In particular, if during an interaction, one or more auditory or visual clinical signs of a patient are presented to the dispatcher, the clinical signs assessment module may assist the dispatcher in determining that the patient in distress would be best suited by an ALS unit. Thus, the dispatcher may then dispatch an ALS unit to the patient.

The facilities that handle 9-1-1 calls are referred to as Public Safety Access Points (PSAPs) which record all call traffic. In some embodiments, an auditory and visual automatic analysis of patient sounds and appearance is utilized to determine the appropriate level of response to a 9-1-1 emergency call. In general, there are two kinds of pre-hospital care providers, Emergency Medical Technicians (EMTs) and Paramedics. An ambulance staffed by two EMTs is considered a Basic Life Support (BLS) unit. Paramedics generally have more training than EMTs. An ambulance staffed by two paramedics (or two licensed mobile intensive care registered nurses) is considered to be an Advanced Life Support (ALS) unit. Some jurisdictions use only ALS units while others have a mixture of BLS and ALS units. The BLS/ALS decision is usually made by a dispatcher at the PSAP by consulting Dispatch Guidecards. An example Dispatch Guidecard can be found on the World Wide Web at state.nj.us/health/ems/documents/guidecard.pdf, which is hereby incorporated by reference for all that it teaches and for all purposes. Moreover, it may be difficult for a call-taker or dispatcher to determine whether a patient would be better served with an ALS or a BLS unit from what he or she hears.

In general, the following non-limiting, exemplary signs related to breathing and speech may be estimated from audio analysis conducted at a PSAP, and thresholds could be set and evaluated to upgrade a BLS dispatch to an ALS dispatch: respiratory rate (for example breaths per minute—normal limits are 12-20 breaths per minute); respiratory rhythm (for example regular or irregular breathing rhythm); noisy respirations (such as crowing or “cawing”); wheezing (breath with a whistling or rattling sound in the chest); gurgling; snoring; stridor (a harsh vibrating noise when breathing), coughing, an inability to speak due to breathing efforts, speaking in less than full sentences due to difficulty breathing, slurring words (as in Cincinnati Prehospital Stroke Scale); and aphasia.

If detected, these signs could upgrade “sick person” BLS calls to “difficulty breathing” or “possible stroke” ALS calls. In some embodiments of the present disclosure, a system may monitor a conversation, analyze the (foreground) speech and (background) respiratory sounds, and display to the call-taker or dispatcher any parameters detected outside of normal limits or beyond set thresholds. In some embodiments, an analysis of the breathing and speech of the speaker may be performed on background sounds in the same room as a caller who is not a patient. Alternatively, a non-patient caller might be requested to hold the phone near the mouth of the patient.

In particular, embodiments that perform automated auditory analyses may recognize and quantify the following issues: (i) Respiratory rate: (a) Time the inhalation when the patient is not speaking; (b) Respiratory rhythm: a measure of regularity (while not speaking) (ii) Respiration noises (iii) Sound detection; (iv) short sentences: (a) Count syllables in utterances. Advanced techniques might be helpful in identifying other clinical signs and issues as well. Moreover, an analysis of a non-calling patient might be particularly helpful in distinguishing agonal respirations from effective breaths in the context of a witnessed cardiac arrest. In instance when agonal respirations are mistaken for effective breaths, that can result in a delay of CPR of many minutes. Allowing a system to interpret breath sounds by holding the phone near the mouth of an unresponsive patient might help to establish both the nature and rate of the respirations.

A method of detecting clinical signs may start by assuming that no baseline information is available for the particular patient or caller. If existing baseline data is in fact available, then the call-taker, dispatcher, or agent might be able to interpret the detected signs in a more useful manner when the information that is collected.

In some embodiments, many of the subtleties of respiration and related sounds might be inadvertently filtered out of the heavily processed telephone audio stream. It would be desirable to transmit in parallel the original, unprocessed input data stream. If the unprocessed input data stream cannot be simultaneously transmitted, then the unprocessed input data stream could be stored a communication endpoint and then transmitted if requested. In particular, many cell phones now go into a special mode when 9-1-1 is dialed; this mode may be extended to store the original audio stream and would be able to transmit it upon request.

In some embodiments, PSAP calls may include a video component in addition to a voice component. The following non-limiting, exemplary signs might be estimated by analyzing an image of a caller: (i) Skin color: (a) Cyanosis—A blue or purplish coloring of skin or mucous membranes; (b) Reddish skin color; (c) Pale (ii) Frothy secretions near the lips; (iii) Chemical burns around the mouth; (iv) Skin moisture—Mild dampness; clamminess; extreme diaphoresis; (v) Pupils: Dilated, asymmetric (vi) Signs of trauma (especially on the face): Deformities, Contusions, Abrasions, Punctures/penetrations, Burns, Lacerations, Swelling; (vii) Jugular Vein Distention; and (viii) Blood or Cerebral Spinal Fluid leakage from ears or nose. For example, some embodiments may analyze the image and then advise the call-taker or dispatcher about any relevant issues. Further, complex facial recognition software may identify any of the above issues. Relatively straightforward facial algorithms may identify appropriate regions of the face (eyes, mouth, ears, nose) and highlight them to remind the call-taker or dispatcher to check for key signs (e.g., highlight the eyes and put a message near there along the lines of “Pupils dilated? Contracted? Equal?”). By automatically assessing for auditory and visual signs on a 9-1-1 call, the correct levels of assistance can be provided.

In one embodiment, one or more clinical signs may be detected at a Public Safety Answering Point (PSAP). The clinical signs may be detected by receiving a contact initiated from a caller; analyzing the contact to determine a contact characteristic; based upon the contact characteristic, delivering call information associated with the contact to a clinical signs detection module; analyzing, by at least one processor, a portion of the call information to detect a clinical sign associated with the contact; and providing the results of the analysis to at least a PSAP agent.

In yet a further embodiment, clinical signs may be detected using a transitory computer readable information storage medium having stored thereon instructions that cause a computing system to execute a method of detecting clinical signs in a Public Safety Answering Point (PSAP) comprising: receiving a contact initiated from a caller; analyzing the contact to determine a contact characteristic; based upon the contact characteristic, delivering call information associated with the contact to a clinical signs detection module; analyzing, by at least one processor, a portion of the call information to detect a clinical sign associated with the contact; and providing the results of the analysis to at least a PSAP agent.

In yet a further embodiment, a system that facilitates detecting clinical signs in a Public Safety Answering Point (PSAP), is provided; the system comprising: a workstation that receives a contact initiated from a caller; a clinical signs analysis module that analyzes the contact to determine a contact characteristic and based upon the contact characteristic, delivers call information associated with the contact to a clinical signs detection module, the clinical signs detection module analyzing a portion of the call information to detect a clinical sign associated with the contact and providing the results of the analysis to a PSAP agent.

The term “caller” as used herein can be construed to include a person or patient that has contacted, or been contacted by, a PSAP. In general, any form of communication medium may be utilized; such as, but not limited to a voice call, a video call, a web call, a chat, a VoIP communication, any known or later developed communications, or combinations thereof. Additionally, a caller may include one or more of a patient in distress, a witness to an emergency, a bystander, or combinations thereof. Moreover, while embodiments of the present disclosure will describe a caller as being a person reporting an emergency to a PSAP, it should be appreciate that embodiments of the present disclosure are not so limited and the clinical signs assessment systems and methods described herein can be utilized in non-emergency contact centers, enterprise contact centers, and the like.

The term “agent” or “PSAP agent” can be construed to include one or more human agents operating one or more contact center endpoints or workstations. In some embodiments, an agent may correspond to a contact center supervisor, a trainee, or an agent. An agent may process or respond to caller with or without the assistance of an automated processing resource. For instance, an automated system may be configured to generate proposed responses or additional questions based upon clinical signs that have been detected and analyzed. An agent may be allowed to select which among the automatically-generated responses are the best responses and/or edit one of the automatically-generated responses. Accordingly, it may be possible that an agent is considered to be “processing” a work item when, in fact, an automated resource is being used to assist the agent in the processing of the work item.

The term “clinical sign” may be understood to be an objective indication, or measure, of some medical fact or characteristic associated with a patient; generally, a clinical sign is observable. For example, a clinical sign may include one or more auditory observations, such as but not limited to breath sounds including, but not limited to respiratory rate, respiratory rhythm, and respiration noises; and speech patterns including but not limited to word usage, frequency, volume, slurring, speech sentence length, and utterances, which may or may not be comprehensible. A clinical sign may include one or more visual observations, such as, but not limited to observations associated with a patient's skin, including but not limited to color, moisture, burns, contusions, abrasions, punctures/penetrations, lacerations, and swelling; observations associated with a specific body part, including but not limited to, frothy secretions near the lips, pupils, swelling, deformities, jugular vein distention, blood or cerebral spinal fluid leakage from ears or nose, etc.; and other general observations associated with a patient, for example, but not limited to movement, position, location, and surroundings.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

Exemplary embodiments of the present disclosure are described in conjunction with the appended figures where:

FIG. 1 is a block diagram of a communication system in accordance with an exemplary embodiment of the present disclosure;

FIG. 2 is a block diagram of a communication server in accordance with an exemplary embodiment of the present disclosure;

FIG. 3 illustrates a clinical audio signs analysis module and a clinical visual signs analysis module in accordance with an exemplary embodiment of the present disclosure;

FIG. 4 depicts a PSAP graphical user interface in accordance with an exemplary embodiment of the present disclosure;

FIG. 5 is a flow diagram depicting a method associated with a communication system in accordance with an exemplary embodiment of the present disclosure;

FIG. 6 is a flow diagram depicting a clinical signs assessment method in accordance with an exemplary embodiment of the present disclosure; and

FIG. 7 is a flow diagram depicting a clinical signs assessment method in accordance with an exemplary embodiment of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

Furthermore, while embodiments of the present disclosure will be described in connection with Public Safety Access Point (PSAP) examples, it should be appreciated that embodiments of the present disclosure are not so limited. In particular, embodiments of the present disclosure can be applied to any contact center construct and, in some embodiments, may also be utilized in non-contact center settings. For instance, any communication scenario involving or requiring the detection and analysis of one or more clinical signs may utilize the embodiments described herein. The usage of PSAP examples is for illustrative purposes only and should not be construed as limiting the claims.

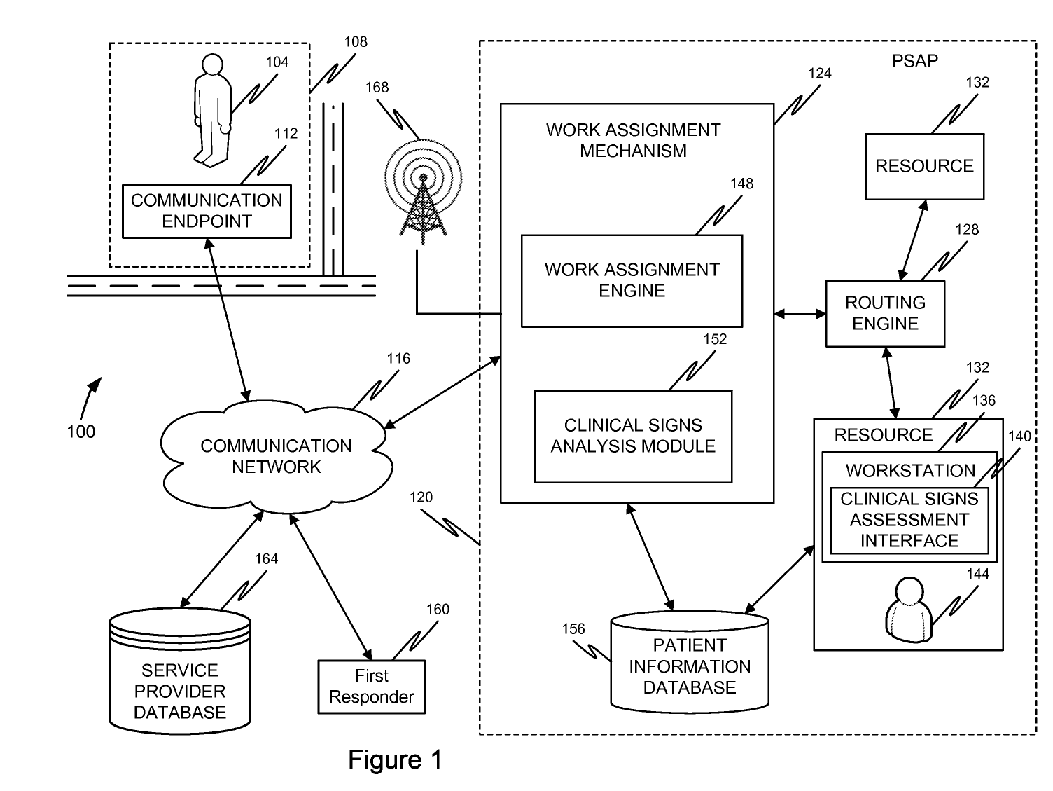

FIG. 1 shows an illustrative embodiment of a communication system 100 in accordance with at least some embodiments of the present disclosure. The communication system 100 may be a distributed system and, in some embodiments, comprises a communication network(s) 116 connecting one or more communication endpoints 112 to a contact center, such as a PSAP 120. In some embodiments the PSAP 120 includes a work assignment mechanism 124, which may be owned and operated by an enterprise or government agency administering a PSAP in which a plurality of resources 132 are distributed to receive and respond to contacts, or calls, from communication endpoints 112. In some embodiments, the PSAP is responsible for answering contacts to an emergency telephone number, such as 9-1-1 (or, for example 1-1-2 in Europe), for police, firefighting, ambulance, and other emergency services. Trained telephone operators, such as agents 144, are usually responsible for dispatching these emergency services. Most PSAPs are now capable of caller location from landline calls, and many can handle mobile phone locations as well (sometimes referred to as phase II location), where the mobile phone company has a handset location system (such as a satellite positioning system). If a governmental entity operates its own PSAP, but not its own particular emergency service (for example, for a city-operated PSAP, there may be county fire but no city police), it may be necessary to relay the call to the PSAP that does handle that type of call.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an IP Multimedia Subsystem (IMS) network, a Voice over IP (VoIP) network, a SIP network, or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the TCP/IP suite of protocols. Communications supported by the communication network 116 include real-time, near-real-time, and non-real-time communications. For instance, the communication network 116 may support voice, video, text, web-conferencing, or any combination of media. Moreover, the communication network 116 may comprise a number of different communication media such as coaxial cable, copper cable/wire, fiber-optic cable, antennas for transmitting/receiving wireless messages, and combinations thereof. In addition, it can be appreciated that the communication network 116 need not be limited to any one network type, and instead may be comprised of a number of different networks and/or network types. For illustrative purposes, a person 104 who experiences an emergency, witnesses an emergency, or is simply a bystander, may use a communication endpoint 112 to initiate contact with, or call into a PSAP 120 via the communication network 116. It should be appreciated that the communication network 116 may be distributed. Although embodiments of the present disclosure will refer to one communication network 116, it should be appreciated that the embodiments claimed herein are not so limited. For instance, multiple communication networks 116 may be joined by many servers and networks.

In accordance with at least some embodiments of the present disclosure, a communication endpoint 112 may comprise any type of known communication equipment or collection of communication equipment. Examples of a suitable communication endpoint 112, may include, but are not limited to, a personal computer or laptop with a telephony application, a cellular phone, a smartphone, a telephone, or other device which can make or receive communications. In general, each communication endpoint 112 may provide many capabilities to the caller 104 who has an emergency. These capabilities may include, but are not limited to, video, audio, text, applications, and/or data communications and the ability to access agents 144 and/or resources 132 as well as other services provided by the PSAP 120. In one application, the communication endpoint 112, as well as the processing resources 132, are video telephony devices (e.g., video phones, telepresence devices, a camera-equipped cellular or wireless phone, a mobile collaboration device, and a personal tablet, or laptop computer with a camera or web camera). The type of medium used by the communication endpoint 112 to communicate with other communication devices 112 or processing resources 132 may depend upon the communication applications available on the communication device 112.

In accordance with some embodiments of the present disclosure, a caller may utilize their communication endpoint 112 to initiate a communication, or contact, with a PSAP, such as PSAP 120, to initiate a work item, which is generally a request for a processing resource 132. An exemplary work item may include, but is not limited to, a multimedia contact directed toward and received at a PSAP. The work item may be in the form of a message or collection of messages that are transmitted from the communication device 112, over the communication network 116, and received at the PSAP 120. For example, the work item may be transmitted as a telephone call, a packet or collection of packets (e.g., IP packets transmitted over an IP network), an email message, an instant message, an SMS message, a fax, a video chat, and combinations thereof. In some embodiments, the communication may not necessarily be directed at the work assignment mechanism 124, but rather be on some other server in the communication network 116 where it is harvested by the work assignment mechanism 124, which generates a work item for the harvested communication. An example of such a harvested communication includes a social media communication that is harvested by the work assignment mechanism 124 from a social media network or server. Exemplary architectures for harvesting social media communications and generating work items based thereon are described in copending U.S. application Ser. Nos. 12/784,369, 12/706,942, and 12/707,277, filed Mar. 20, 2010, Feb. 17, 2010, and Feb. 17, 2010, respectively, each of which are hereby incorporated herein by reference in their entirety for all that they teach and for all purposes.

The format of a work item may depend upon the capabilities of the communication endpoint 112 and the format of the communication. In particular, work items may be logical representations within a PSAP of work to be performed in connection with servicing a communication received at the PSAP, and more specifically, the work assignment mechanism 124. The communication may be received and maintained at the work assignment mechanism 124, a switch or server connected to the work assignment mechanism 124, or the like until a resource 132 is assigned to the work item representing the communication at which point the work assignment mechanism 124 passes the work item assignment decision to a routing engine 128 to connect the communication endpoint 112 which initiated the communication with the assigned or selected resource 132.

Although the routing engine 128 is depicted as being separate from the work assignment mechanism 124, the routing engine 128 may be incorporated into the work assignment mechanism 116, or its functionality may be executed by the work assignment engine.

In accordance with at least some embodiments of the present disclosure, the work item is sent toward a collection of processing resources 132 via the combined efforts of the work assignment mechanism 124 and a routing engine 128. The resources 132 can either be completely automated resources (e.g., Interactive Voice Response (IVR) units, processors, servers, or the like), human resources utilizing communication devices (e.g., one or more human agents 144 utilizing a computer, telephone, laptop, etc.), or any other resource known to be used in a PSAP environment.

As discussed above, the work assignment mechanism 124 and resources 132 may or may not be owned and operated by a common entity in a contact center format. In some embodiments, the work assignment mechanism 124 may be administered by multiple enterprises, each of which has their own dedicated resources 132 connected to the work assignment mechanism 128.

In some embodiments, the work assignment mechanism 124 comprises a work assignment engine 148 which enables the work assignment mechanism 124 to make intelligent routing decisions for work items. In some embodiments, the work assignment engine 148 is configured to administer and make work assignment decision in a queueless contact center, as is described in copending U.S. application Ser. No. 12/882,950, the entire contents of which is hereby incorporated herein by reference for all that it teaches and for all purposes.

More specifically, the work assignment engine 148 can determine which of the plurality of processing resources 132 is qualified, skilled, and/or eligible to receive the work item and further determine which of the plurality of processing resources 132 is best suited to handle the processing needs of the work item. In situations of work item surplus, the work assignment engine 132 can also make the opposite determination (i.e. determine optimal assignment of a resource 132 to a work item). In some embodiments, the work assignment engine 148 may be configured to achieve true one-to-one matching by utilizing bitmaps/tables and other data structures.

The work assignment engine 148 may reside in the work assignment mechanism 124 or in a number of different servers or processing devices. In some embodiments, cloud-based computing architectures can be employed whereby one or more components of the work assignment mechanism 124 are available in a cloud or network such that they can be shared among a plurality of different users.

As previously discussed, a Public Safety Access Point (PSAP) 120 may typically be a contact center that answers calls to an emergency telephone number. Examples of services that may be offered by a PSAP 120 via the communication network 116 include communication services, media services, information services, processing services, application services, combinations thereof, and any other automated or computer-implemented services, applications, or telephony features. Trained call-takers, or agents 144, may attempt to address emergencies using procedural guidelines and experiential knowledge. For example, a Dispatch Guidecard may be utilized such that agents 144 provide an appropriate level of response to an event or emergency. The Dispatch Guidecards may be electronically displayed at a dispatcher workstation 136; moreover, the Dispatch Guidecards may provide prompting to a call-taker or dispatcher such that a dispatcher 144 communicates with the caller in such a way as to receive information regarding the event or emergency from the caller 104.

In addition to comprising a work assignment engine 148, the work assignment mechanism may also comprise a clinical signs detection module 152 that may include one or clinical sign detection modules and algorithms to detect and make sense of auditory and visual clinical signs presented by one or more callers. The clinical signs analysis module 152 may work to augment or assist agent 144 when dispatching resources to an emergency event. For example, in some embodiments consistent with the present disclosure, an agent 144 may utilize a clinical signs assessment interface 140; the clinical signs assessment interface 140 may reside on the agent workstation 136 and may provide the agent 144 with detected auditory and/or visual clinical signs that relate to the caller 104. These clinical signs that are displayed on the clinical signs assessment interface may assist an agent when dispatching resources to an event or an emergency, as will be described later.

Resources dispatched to an event or emergency are usually termed first responders. A first responder 160 may be a first person or persons sent out, or dispatched, in an emergency and/or in response to a 9-1-1 call; the first responder 160 may be the first medically trained person who arrives at an event. Typically in the United States and Canada, the first responder 160 may be a firefighter, a police officer, or an emergency medical services (EMS) team/unit. The goal of the first responder 160 may be to provide first aid, stabilization, and/or transport prior to more advanced providers arriving at the event or providing care at a secondary location. Moreover, the first responder 160 dispatched to an emergency or event may be dependent upon the severity of the event, the type of event, and/or one or more clinical signs provided to a an agent 144. As previously discussed, these clinical signs may comprise one or more of auditory and visual clinical signs. In accordance with some embodiments of the present disclosure, these clinical signs may be detected from one or more audio and video signals provided by a communication endpoint 112 for analysis by a clinical signs assessment module 152.

The communication endpoint 112 may have information associated with it that is useful to the PSAP 120. For example, the information may include the name, number, and location 108 of a caller 104. Location determination typically depends upon information stored and/or maintained in an Automatic Location Information (ALI) database. A service provider database 164 typically allows a PSAP 120 to look up an address that is associated with the caller's telephone number and/or endpoint 112. A wireless connection and/or cellular tower 164 may contain equipment including antennas, Global Positioning System (GPS) receivers, control electronics, digital signal processors (DSPs), transceivers, and backup power sources. The wireless connection and/or cellular tower 168 may be operable to carry and handover telephony and/or data traffic for communication devices 112, within a specified range, for communication with other communication devices 112, PSAP 120, and first responders 160, that may be accessible through the communication network 116.

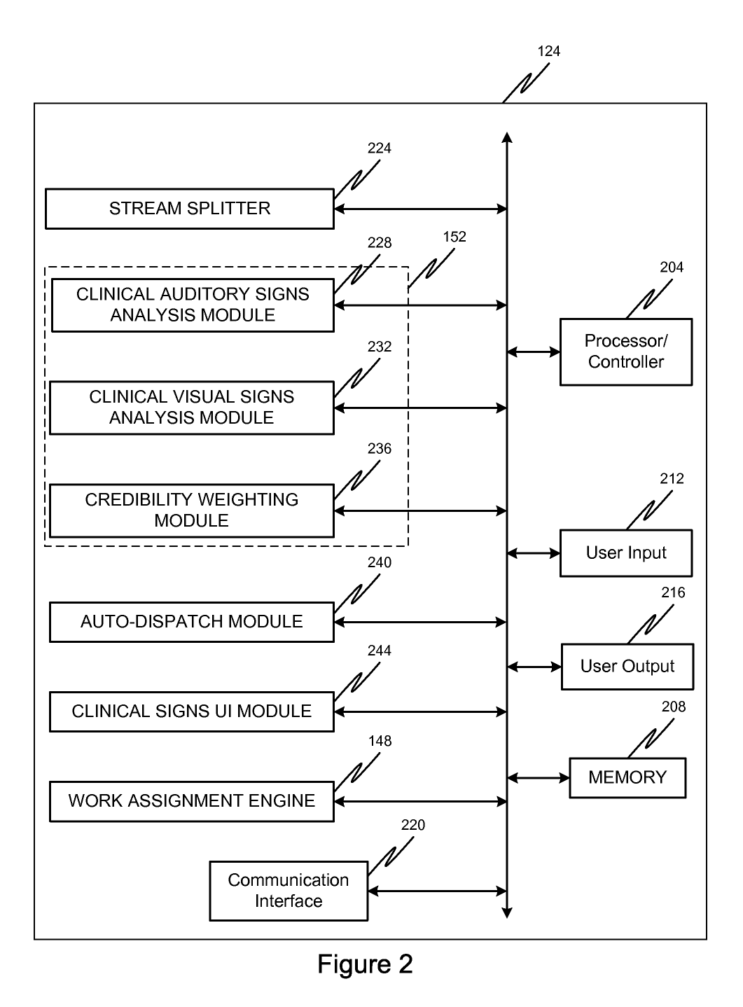

FIG. 2 illustrates a block diagram depicting one or more components of a PSAP work assignment mechanism 124 in accordance with at least some embodiments of the present disclosure. In some embodiments, the work assignment mechanism 124 may include a processor/controller 204 capable of executing program instructions. The processor/controller 204 may include any general purpose programmable processor or controller for executing application programming. Alternatively, or in addition, the processor/controller 204 may comprise an application specific integrated circuit (ASIC). The processor/controller 204 generally functions to execute programming code that implements various functions performed by the associated server or device. The processor/controller 204 of the work assignment mechanism 124 may operate to route communications and present information to an agent workstation 136, and optionally to a first responder 160 as described herein.

The work assignment mechanism 124 may additionally include memory 208. The memory 208 may be used in connection with the execution of programming instructions by the processor/controller 204, and for the temporary or long term storage of data and/or program instructions. For example, the processor/controller 204, in conjunction with the memory 208 of the work assignment mechanism 124, may implement emergency services telephony, application, and web services that are needed and accessed by one or more communication endpoints 112, the PSAP 120, and first responders 160.

The memory 208 of the work assignment mechanism 112 may comprise solid state memory that is resident, removable and/or remote in nature, such as DRAM and SDRAM. Moreover, the memory 208 may comprise a plurality of discrete components of different types and/or a plurality of logical partitions. In accordance with still other embodiments, the memory 208 comprises a non-transitory computer readable storage medium. Such a medium may take many forms, including but not limited to, non-volatile media, volatile media, and transmission media.

The work assignment mechanism 124 may include a stream splitter 224; a clinical signs analysis module 152—including a clinical auditory signs analysis module 228, a clinical visual signs analysis module 232 and a credibility weighting module 236; an auto-dispatch module 240, a clinical signs user interface (UI) module 244, and a work assignment engine 148, to provide access to and capabilities of the PSAP 120 that may be executed by the modules. Moreover, content from the modules may include information that is rendered by the clinical signs UI module 244 for display on the agent workstation 144.

In addition, user input devices 212 and user output devices 216 may be provided and used in connection with the routing and processing of calls to a PSAP 120 for handling by an agent 144. However, the agent 144 typically interfaces with a PSAP 120 through an agent workstation 136, where the agent workstation 136 each is associated with one or more user inputs and one or more user outputs. Examples of user input devices 212 include a keyboard, a numeric keypad, a touch screen, a microphone, scanner, and pointing device combined with a screen or other position encoder. Examples of user output devices 216 include a display, a touch screen display, a speaker, and a printer. The work assignment mechanism 124 also generally includes a communication interface 220 to interconnect the work assignment mechanism 124 to the communication network 116.

The stream splitter 224 may operate to provide one or more duplicate streams of information that is transmitted as part of the call; the stream splitter 224 may further operate to provide separate instances of audio and visual information that is transmitted as part of the call. For example, the stream splitter 224 may split an incoming call from caller 104 such that at least one instance of the audio information transmitted as part of the call is provided to clinical signs analysis module 228. In accordance with some embodiments of the present disclosure, the stream splitter 224 may operate to split an incoming call from caller 104 such that at least one instance of audio information that is transmitted as part of the call is provided to the clinical auditory signs analysis module 228, one instance of video information that is transmitted as part of the call is provided to the clinical visual signs analysis module 232, and at least one instance of the audio and video information that is transmitted as part of the call is provided to the resource 132, agent workstation 136, and/or agent 140. By creating one or more duplicate instances of audio information, video information, and/or a combination of audio and video information, the ability for an agent 144 to hear and understand any speech that may be present may be improved. Additionally, as each of the clinical auditory signs analysis module 228 and the clinical visual signs analysis module 232 may receive a duplicate copy, or instance, of the information that was transmitted as part of the call, each analysis module 228, 232 can optimize the received instance for audio analysis and/or video analysis without affecting or compromising the information utilized by the other module. For example, video analysis performed on one stream of information may negate or render unusable the associated audio portion; thus, if the video analyzed stream of information were provided to the auditory signs analysis module 228, the detection of auditory signs may be limited since the audio portion may be unusable. Therefore, by providing an instance of the information that was transmitted as part of the call to each module, each module can utilize the received instance without affecting or compromising ability of the other module to detect clinically significant information.

The auto-dispatch module 240 may operate to automatically dispatch resources based upon one or more of a detected clinical signs. For example, the clinical auditory signs analysis module 228 and a clinical visual signs analysis module 232 may together, or separately, provide an indication to the work assignment mechanism 124 that the detected clinical signs of a contact, or caller, suggest a specific type of response. In instances where policy allows for automatic dispatch, and/or in situations where an agent 144 is not available to verify or confirm the response to an event or emergency, the auto-dispatch module 240 may cause an appropriate level of response, such as a BLS and ALS resource 160 to be dispatched. For example, the clinical auditory signs module 228 may detect that a caller 104 exhibits multiple ongoing instances of slurred speech. Additionally, the clinical visual signs module 232 may detect that a caller 104 appears to display a facial droop. In response to these two detected clinical signs, the auto-dispatch module 240 may automatically send a BLS and ALS unit to a detected location 108 of the caller 104. Alternatively, or in addition, the auto-dispatch module may require that the number of detected clinical signs be above a threshold, a certain type of clinical sign be detected, and/or a certain confidence related to each detected clinical sign be above a threshold, prior to automatically dispatching resources, such as one or more first responders 160.

The credibility weighting module 236 may determine one or more weighting factors associated with each of a clinical audio sign and a clinical visual sign. For example, in some instances, historical information associated with a caller 104 may reside in the patient information database 156. As a caller 104 initiates contact with a PSAP 120, the work assignment mechanism may retrieve this information and make this information available to one or more of the clinical audio signs analysis module 228, the clinical visual signs analysis module 232, and the credibility weighting module 236. Assuming that the clinical signs exhibited by the caller 104 are similar to the previously detected clinical signs associated with the caller 104 retrieved from the patient information database 156, the credibility weighting module 236 may associate a higher credibility to one or more of detected clinical signs exhibited currently by the caller 104. This credibility factor may then be utilized by the clinical signs UI module 244, the auto-dispatch module 240 (as previously mentioned), and/or the work assignment engine 148.

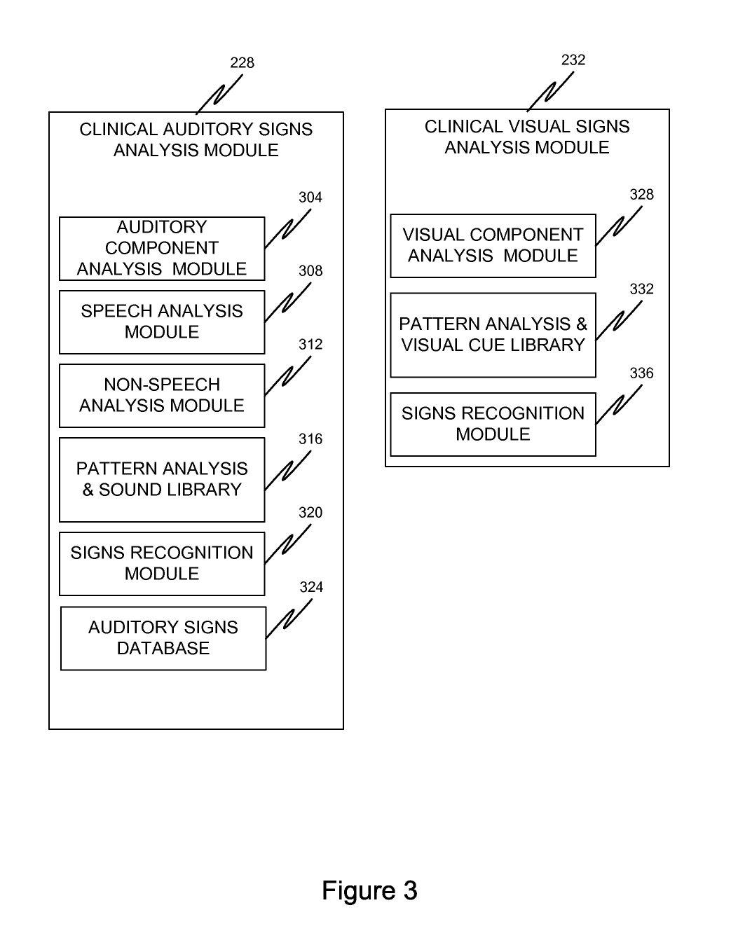

As shown and depicted in FIG. 3, the clinical audio signs analysis module 228 may further include one or more modules to facilitate the detection and analysis of audio information transmitted as part of the contact or call. As previously discussed, the work assignment mechanism 124 may include a stream splitter 224 that may separate and split audio information included as part of a call from caller 104; this audio information may be provided to the auditory component analysis module 304. The auditory component analysis module 304 may operate to analyze this audio information and separately extract speech components from non-speech components for additional analysis. Alternatively, or in addition, the auditory component analysis module 304 may extract speech components and specifically identify the speech components as such. The auditory component analysis module 304 may additionally separate and identify, or match, one or more speech components, or one or more characteristics of the speech components, with one or more voices detected on a call from a caller 104. Often in audio calls, more than one voice may be detectable on a call; the auditory component analysis module 304 may separately identify each voice as being associated with one or more individuals. For example, voice fingerprinting may be used to separate and identify speech components; those speech components that are determined to be the clearest may then be analyzed using the speech analysis module 308. Alternatively, or in addition, all speech components detected, regardless of the individual to whom they belong, are analyzed at the speech analysis module 308.

The auditory component analysis module 304 may additionally identify non-speech components of the transmitted audio information. In instances where breath sounds, for example, are included separately or in addition to speech components, the auditory component analysis module 304 may specifically identify these sounds as breath sounds based on one or more characteristics. For instance, characteristics of breath sounds may be matched and compared to characteristics in the pattern analysis and sound library 316 that are indicative of known breath sound. The breath sounds may be extracted from the audio information and flagged as such for further analysis by the non-speech analysis module 312. Alternatively, or in addition, background noises that have been determined not to be of any clinical significance, such as bells, sirens, gunshots, vehicle noises, and the like, may be separately identified and removed from the audio information prior to analysis.

In accordance with some embodiments of the present disclosure, the stream splitter 224 may split the instance of the audio portion into duplicate first and second instances, such that a first instance of an audio signal is provided to a speech analysis module 308 and a second duplicate instance of an audio signal is provided to the non-speech analysis module 312.

Upon receiving audio information containing speech components, the speech analysis module 308 may initiate an analysis of these speech components for the detection of clinical signs. For example, the speech analysis module 308 may convert each detected speech component into a word or syllable and cause each converted speech component to be stored in the auditory signs database 324. For instance, a speech to text operation may be performed such that the detected speech components are converted into words. Alternatively, or in addition, the speech analysis module 308 may cause each speech component to be stored in the auditory signs database 324 as audio information, audio data, or raw audio data—such as an audio waveform. Each stored converted speech component or stored audio waveform may then be compared to speech information in a pattern analysis and sound library 316. For example, characteristics of the speech components may be determined and compared to characteristics of speech components indicative of known clinical signs. For instance, the speech analysis module 308, in conjunction with a pattern analysis & sound library 316, may then determine that one or more words and/or one or more phrases are repetitively present in the audio information received from a caller 104 using one or more of the stored converted speech components and the stored audio waveforms. Alternatively, or in addition, the speech analysis module 308 in conjunction with a pattern analysis & sound library 316 may determine that the caller 104 is slurring one or more words and/or one or more phrases, as detected by one or more of the stored converted speech components and the stored audio waveforms. As an indication that the caller 104 experiences one or more of the above may be indicated to the clinical signs UI module 244 as “repetitive word use” or “slurred speech”.

Alternatively, or in addition, the speech analysis module 308 may analyze each word that has been used and/or detected to determine whether or not the word has been used within the appropriate context by comparing one or more words and/or one or more phrases to words and phrases contained in a pattern analysis and sound library 316. For example, the speech analysis module 308 may utilize the pattern analysis and sound library 316 to determine whether the caller 104 speaks in single words; speaks in short, fragmented phrases; omits smaller words like “the,”, “of,” and “and”; puts words in the wrong order; switches sounds and/or words (e.g. coat is called a lamp or a monitor is called a ponitor); makes up words; and/or experiences difficulty recalling words. As an indication that the caller 104 experiences one or more of the above may be indicative of aphasia, the speech analysis module 308 may indicate that caller 104 exhibits one or more clinical signs, such as “words in wrong order” to the clinical signs UI module 244.

Upon receiving audio information containing non-speech components, the non-speech analysis module 312 may initiate an analysis of these non-speech components for the detection of clinical signs. For example, characteristics of the extracted non-speech components may be determined and compared to characteristics non-speech components indicative of known clinical signs. For instance, the non-speech analysis module 312 may detect one or more breath sounds from a caller 104. The non-speech analysis module 312 may then determine breath information, such as but not limited to, one or more of a respiratory rate, an inhalation time, an exhalation time, a time between inhalation and exhalation, a time between exhalation and inhalation, a respiratory rhythm, quality, and any noises (such as crowing, crawing, wheezing, whistling, rattling, gurgling, snoring, stridor, and/or coughing) associated therewith. The non-speech analysis module may convert or characterize each detected non-speech component such that the non-speech component can be stored in the auditory signs database 324. The non-speech analysis module 312 may store breath information in an auditory signs database 324 and then compare or match the stored breathe information, or characteristics of the breath information, to breath information, or characteristics of breath information, contained in the pattern analysis and sound library 316 known to be associated with one or more clinical signs. If any of the detected and stored breath information matches patterns or sounds determined to be of clinical significance (and previously stored in the pattern analysis and sound library 316), then an indication that the caller 104 is exhibiting one or more of the above may be indicated to the clinical signs UI module 244 as “breath irregularity” or “gurgling breath sounds”, for example.

In some instances, a caller 104 may be speaking and exhibiting one or more clinical signs; thus the speech analysis module 308 and the non-speech analysis module 312 may operate together to determine whether or not a caller 104 is exhibiting any clinical signs. For example, the speech analysis module 308 and the non-speech analysis module 312 may operate together to determine whether or not a caller 104 is speaking in short, fragmented phrases or in single words. As another example, the speech analysis module 308 and the non-speech analysis module 312 may operate together to determine a respiratory rate while the caller 104 is talking; determine whether or not the speech sounds are more similar to known speech sounds, clinical breaths sounds, or a combination thereof. Additionally, the speech analysis module 308 and the non-speech analysis module 312 may work together to determine whether the detected breathing sounds are more likely resulting from speech-related clinical signs, or if the detected speech-related clinical signs are more likely resulting from breath-related clinical signs. If any of the detected breath information and/or speech information is likely to be of clinical significance then an indication may be provided to the clinical signs UI module 244 as such.

In addition to the clinical auditory signs analysis module 228, the clinical signs analysis module 152 may also include a clinical visual signs analysis module 232 for detecting any clinical signs that may be detectable from a video-related portion of call information from a caller 104. As previously discussed, the stream splitter 224 may operate to split an incoming call from caller 104 such that at least one instance of audio information that is transmitted as part of the call is provided to the clinical auditory signs analysis module 228 and one instance of video information that is transmitted as part of the call is provided to the clinical visual signs analysis module 232. Upon receiving video information at the clinical visual signs analysis module 232, the clinical visual signs analysis module 232 may utilize video analytics and/or video content analysis algorithms, such as computer vision, pattern analysis, machine intelligence, expert system(s) and combinations thereof to detect, recognize, or otherwise sense clinical signs that are visual in nature. For example, video analytics uses computer vision algorithms to enable it to perceive or see and machine intelligence to interpret, learn and draw inferences. Video analytics can understand a scene, which differs from motion detection. In addition to detecting motion, video analytics can qualify the motion as an object, understand the context around the object, and track the object through the scene. Commonly, video analytics detects changes occurring over successive frames of video, qualifies these changes in each frame, correlates qualified changes over multiple frames, and interprets these correlated changes.

For example, the clinical visual signs analysis module 232 may recognize clinical signs associated with a caller 104. The visual signs and analysis module 232 may detect one or more clinically significant visual indicators associated with caller 104, such as but not limited to, caller 104's skin color (a blue or purplish coloring of the skin or mucous membrane that indicative of cyanosis; a pale skin color; a reddish brown skin color); any frothy secretions near caller 104's lips; any chemical burns around caller 104's mouth; the skin moisture of caller 104; the skin temperature of caller 104 (for example, infrared detection), any signs of trauma (for instance, deformities, contusions, abrasions, punctures, penetrations, burns, lacerations, swelling); jugular vein distention; blood or cerebral spinal fluid leakage from the ears or nose; and/or asymmetric or dilated pupils.

The clinical visual signs analysis module 232 may operate in a manner similar to that which is described in copending U.S. application Ser. No. 13/447,943 the entire contents of which is hereby incorporated herein by reference for all that it teaches and for all purposes. For example, the visual component analysis module 328 may perform a segmentation operation to detect changes, measure a degree of change, localize a change, and extract any relevant changes for further analysis and qualification. As one example, the visual component analysis module may detect a change a caller 104's skin color, such that this change in skin color is compared to a pattern or visual cue located in the pattern analysis and visual cue library 332. Moreover, the signs recognition module 336 may classify or recognize that the skin color of caller 104 may be a clinical sign; accordingly, the clinical visual signs analysis module 232 may provide an indication representing such to the clinical signs UI module 244.

As another example, the visual component analysis module 328 may localize or segment a specific body part, or feature of a caller 104, for example caller 104's pupils. The visual component analysis module 328 may compare each of caller 104's pupils to one another and determine whether or not caller 104's left eye pupil is similar in size to caller 104's right eye pupil (equal or unequal). Moreover, the visual component analysis module 328 may compare the relative sizes of caller 104's pupils to pupil sizes or average pupils located in the pattern analysis and visual cue library 332 to determine if one or both pupils are dilated, constricted, or normal. In some instances, pupil sizes of unequal size (e.g. one pupil dilated and the other pupil constricted) may be indicative of one or more injuries or conditions, the detection of unequal pupils serving as a clinical sign of such injury or condition.

Alternatively, or in addition, the visual component analysis module 328 may analyze the reactivity of each pupil. For example, the visual component analysis module 328 may classify each pupil as being reactive or unreactive to a light source; the reactivity of each pupil may be analyzed independently or the reactivity of each pupil may be determined by comparing the reactivity of each pupil to one another. In such instances where the caller 104's pupils are not equal and reactive to light, the signs recognition module 336 may recognize, or determine, that caller 104's pupils exhibit a clinical sign, such as one pupil constricting much faster than the other pupil. Clinical visual signs analysis module 232 may then provide an indication to the clinical signs UI module 244 representing that one of caller 104's pupils is slow to constrict when presented with a light source. In some embodiments, where the caller 104's pupils are not equal and reactive to light, the clinical signs UI module 244 may indicate that such a clinical sign has been detected by visually highlighting caller 104's pupils in a video stream featuring caller 104.

In addition to detecting and analyzing one or more auditory and visual signs, the clinical signs analysis module 152 may also analyze the history of one or more clinical signs to determine a change in the clinical sign and/or to determine a clinical sign trend or pattern. In many instances, a detected clinical sign may provide valuable information about a caller or patient in distress; however, the detected clinical sign may change over time, such as during the call to a PSAP. Detecting this change may provide additional information regarding the caller's condition and status. For example, utilizing breath sounds during a call, a caller's respiratory rate may be detected as previously discussed and the initial respiratory rate may be utilized to establish baseline respiratory information concerning the caller. Assuming a caller's respiratory rate changes little over a specified amount of time and that the respiratory rate is within the normal range, the clinical signs analysis module 152 may determine that the caller's breathing is stable. In other instances, a caller's respiratory rate may diverge from the baseline data such that the divergence indicates a more serious condition. As one example, a detected change in the respiratory rate may indicate that a caller's respiratory rate is increasing; depending on the magnitude of the change, the caller may be in a serious condition. For example, if a caller presented the following detectable minute by minute respiratory rates of 22, 22, 22, 23, 23, 23, 24, 24, though the overall trend of the respiratory rate is increasing and the rate is diverging from the baseline data, a caller presenting minute by minute respiratory rates of 22, 24, 26, 28, and 30 would be getting much worse more quickly. The clinical signs analysis module 152 may detect these trends and/or patterns and may provide the trend and/or pattern to the clinical signs assessment interface 140 such that the trend and/or pattern may be presented to an agent 144.

As previously mentioned, the clinical signs analysis module 152 may further detect one or more patterns that may be associated with a clinical sign. For example, a caller may exhibit a detectable respiratory rate of 22, 24, 24, 26, 24, 22, 20, 19, 18, 17, 16, 16, 16, 15, 15, 14; the clinical signs analysis module 152 may initially detect the that the trend associated with the respiratory rate is increasing and may further provide an indication of this trend to the clinical signs assessment interface 140. However, after a few additional respiratory rates are detected, the trend starts reversing; that is, the respiratory rates start decreasing. Such a pattern may be associated with a caller experiencing a bout of anxiety associated with the emergent event. The clinical signs analysis module 152 may associate such a respiratory rate pattern to anxiety and may further indicate this to the clinical signs assessment interface 140.

Although the examples above focus on respiratory rates and breathing sounds, a change in other clinical signs may be detected by the clinical signs analysis module 152. For example, the agent 144 may not notice—but it would be important to know, that in addition to the caller's breath sounds, word pronunciation and/or skin color are changing during a call. The clinical signs analysis module 152, having detected these changes throughout the call, may provide the necessary information to the agent 144 such that an appropriate response level is dispatched to handle an allergic reaction requiring prompt attention. For instance, the clinical signs analysis module 152 may detect trends relating to the mispronunciation of words, the general changing of skin color, and/or the swelling of one or more areas of the face. The clinical signs analysis module 152 may then provide an indication to the clinical signs assessment interface 140 such that an agent 144 is alerted to these trends.

Moreover, the various modules of the clinical signs analysis module 152 may operate to detect and track one or more clinical signs associated with circulatory shock. As one example, the clinical signs analysis module 152 may detect a bluing of the skin and a shortening of a caller's breaths—clinical signs associated with initial stages of shock. As the caller moves into compensatory shock, the clinical signs analysis module 152 may detect an increased respiratory rate. Having detected two stages of shock, the clinical signs analysis module 152 may provide an indication to the clinical signs assessment interface 140 specifically alerting the agent 144 to the possibility of shock. Thus, the agent 144 may be more informed when dispatching response units to assist the caller.

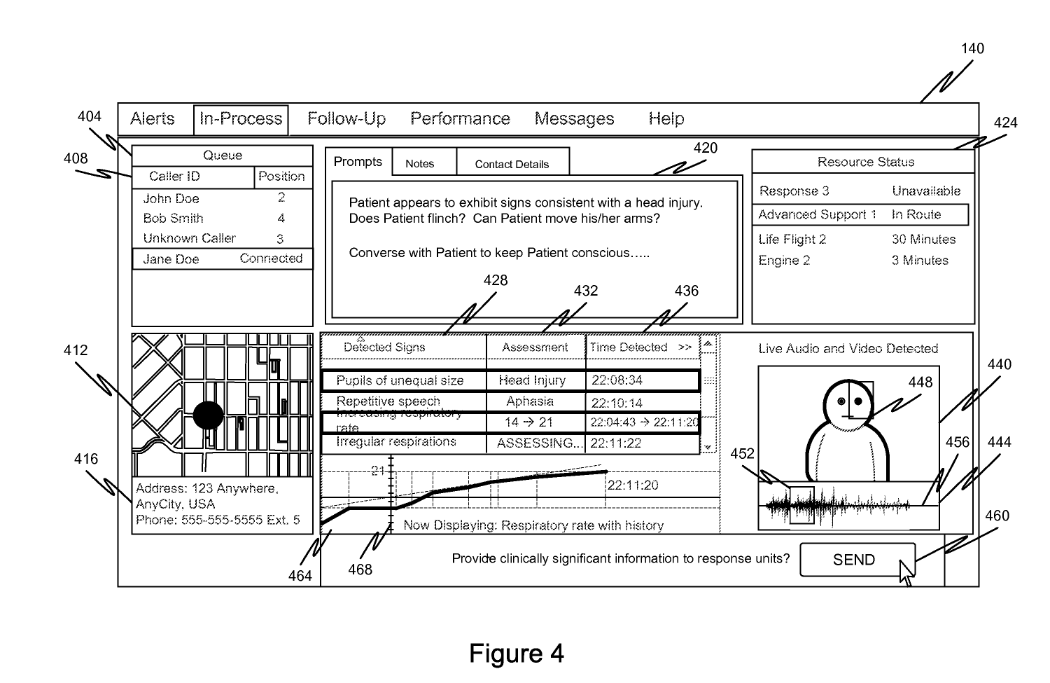

Referring now to FIG. 4, in some embodiments an agent's workstation 136 may include a clinical signs assessment interface 140, such as the clinical signs assessment interface depicted in FIG. 4. The clinical signs assessment interface 140 may include a queue area 404 that provides an indication to an agent 144 of a queue status 404. Queue status 404 may include the name of the caller and the caller positions. The clinical signs assessment interface 140 may also include a location of the currently connected caller. For example, Jane Doe is the currently connected caller; an agent may be provided with a visual map display of Jane Doe's location 412 and Jane Doe's address, 416.

The clinical signs assessment interface 140 may also provide an agent 144 with necessary status information pertaining to one or more first responders 160. For example, the clinical signs assessment interface 140 may provide resource status area 424 indicative of each of the first responder's status, availability, and name or radio ID.

In accordance with some embodiments of the present disclosure, the clinical signs assessment interface 140 may provide a detected signs summary 428 illustrating clinical signs that have been detected for a caller 104. The clinical signs assessment interface 140 may additionally display information associated with the detected signs summary 428, including a general high level assessment and a time in which the clinical sign was detected. Additionally, the clinical signs assessment interface may include an electronic prompt area 420. Electronic prompt area 420 may provide specific guidance to an agent 144; the guidance may be specific to the clinical signs that have been detected. Alternative, or in addition, the guidance, or prompts, provided by the electronic prompt area 420 may correspond to one or more Dispatch Guidecards and/or be augmented by the detected clinical signs.

Alternatively, or in addition, the clinical signs assessment interface 140 may further highlight or make obvious to an agent 144 one or more detected clinical signs. For example, when a video feed is available for a caller 104, the video may be displayed in video area 440; a detected clinical sign, such as “pupils of unequal size” may be specifically highlighted in video area 440. Such an indication draws attention to a particular clinical visual sign such that minimal effort is required on the part of the agent 144. Additionally, an audio area 444 may display an audio waveform 456 associated with a caller 104 such that an auditory clinical sign 452 is highlighted or made obvious to an agent 144. In some embodiments, an agent 144 may have the option to send the detected auditory and visual clinical signs to one or more of the first responder units, such as first responder 156. For example, an agent 144, utilizing a button, such as button 460, may send one or more detected clinical signs, and/or including the applicable history of the detected clinical signs, to response units and/or one or more healthcare providers. Alternative, or in addition, the detected clinical signs, and/or including the applicable history of the detected clinical signs, may be automatically sent to one or more response units and/or one or more healthcare provider. The clinical signs that are transmitted may provide the response units and/or the healthcare providers with a broader context in which to interpret their own findings. Moreover, the clinical signs assessment interface 140 may automatically synchronize and/or store the information associated with a caller 104 into the patient information database 156.

In accordance with embodiments of the present disclosure, the clinical signs assessment module 140 may also include one or more clinical sign history areas 464 to display historical data associated with a caller 104 to an agent 144. The clinical sign history area 464 may include one or more charts 468 illustratively displaying the detected history of one or more clinical signs. For example, chart 468, in FIG. 4, illustrates the detected respiratory rate and historical information associated with a caller 104; the chart may include one or more trend-lines and further include clinical sign high and low indicators such that an agent 144 can quickly obtain clinical information concerning the caller 104. Moreover, the clinical signs analysis module 152 may specifically cause trends, patterns and the like to be highlighted such that an agent 144 is quickly alerted to changing clinical signs.

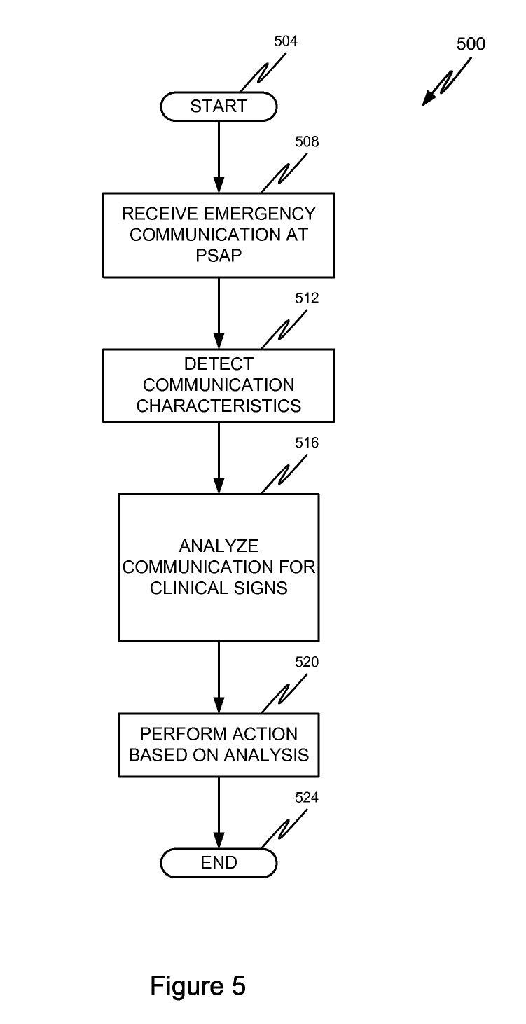

Referring now to FIG. 5, a method 500 of applying the work assignment mechanism 124 will be discussed in accordance with embodiments of the present disclosure. Method 500 is in embodiments, performed by a device, such as work assignment mechanism 124. More specifically, one or more hardware and software components may be involved in performing method 500. In one embodiment, one or more of the previously described modules perform one or more of the steps of method 500. The method 500 may be executed as a set of computer-executable instructions executed by a computer system and encoded or stored on a computer-readable medium. Hereinafter, the method 500 shall be explained with reference to systems, components, modules, software, etc. described with FIGS. 1-5.

Method 500 may continuously flow in a loop, flow according to a timed event, or flow according to a change in an operating or status parameter. Method 500 is initiated at step 504 where a caller 104 may initiate a call to a PSAP 120. At step 508, the call is received at the PSAP 120. At step 512, the contact is received, typically in a queue, and the audio and video capability of the contact may be sensed. For example, if the contact, or call, only has the capability to send audio, then at step 512, an audio-only call is sensed. If, on the other hand, the communication endpoint 112 is capable of providing both audio and video, then a multimedia call comprising audio and video may be sensed. It should be noted that receiving a contact in queue may be a simulated, real-time, and/or near-real-time event and may be at least one of a fictitious, real, and/or recording of an actual contact. Moreover, the contact may be received in the queue by a number of different methods, including, but in no way limited to, assignment by the work assignment engine 148, routing engine 128, manual placement, computer testing and/or development, and/or any combination thereof.

At step 516, the call information comprising audio, video, text, and combinations thereof is provided to the clinical signs analysis module 152, where the communication is analyzed for clinical signs, such as the signs described with reference to the clinical auditory signs analysis module 228 and the clinical visual signs analysis module 232, and as further described herein. Once the communication has been analyzed for clinical signs, the method proceeds to step 520 where one or more actions may be performed based on the analysis. For example, based on the analysis, a clinical signs assessment interface 140 may be updated with the latest clinical sign detection information. Alternatively, or in addition, an auto-dispatch may be initiated based on the analysis. As another option, an agent 144 may be apprised of the detected clinical signs via one or more whisper tones. As yet another example, prompt area 420 may be updated with prompts to provide additional guidance to an agent 144 that is associated with, or based on, one or more detected clinical signs, or lack thereof. Method 500 then ends at step 524.

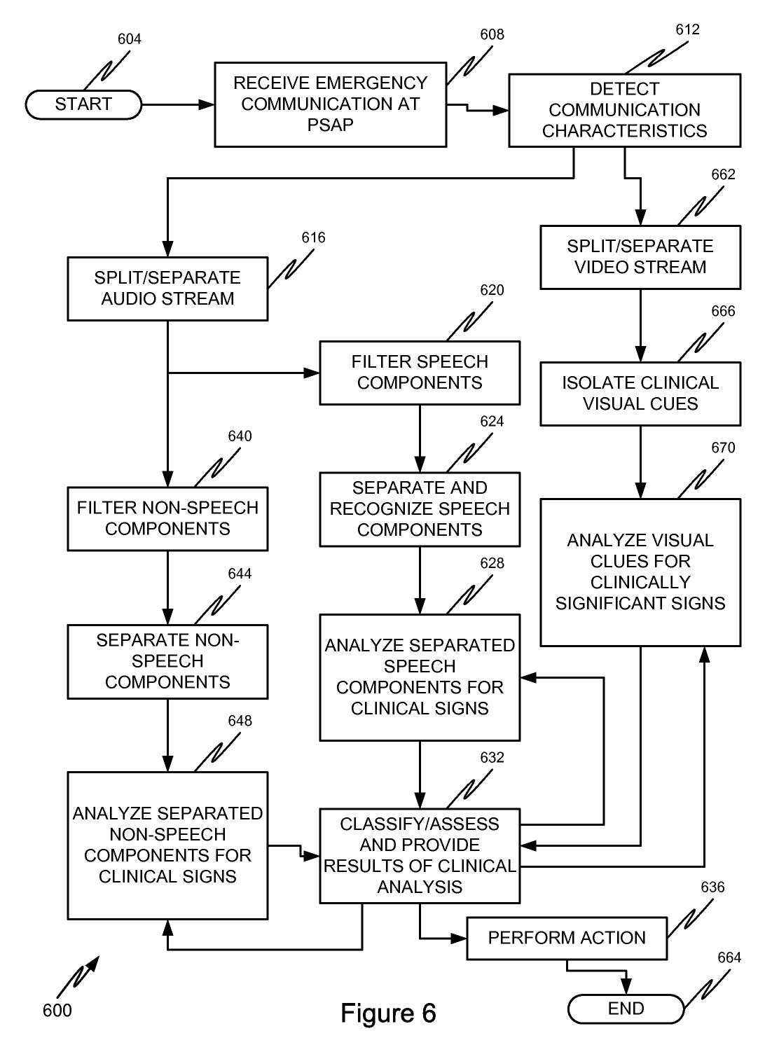

Referring now to FIG. 6, a method 600 providing additional detail with regard to step 516 will be discussed in accordance with embodiments of the present disclosure. Method 600 is in embodiments, performed by a device, such as work assignment mechanism 124. More specifically, one or more hardware and software components may be involved in performing method 600. In one embodiment, one or more of the previously described modules perform one or more of the steps of method 600. The method 600 may be executed as a set of computer-executable instructions executed by a computer system and encoded or stored on a computer-readable medium. Hereinafter, the method 600 shall be explained with reference to systems, components, modules, software, etc. described with FIGS. 1-4.

Method 600 may continuously flow in a loop, flow according to a timed event, or flow according to a change in an operating or status parameter. Method 600 is initiated at step 604 where a caller 104 may initiate a call to a PSAP 120. At step 608, the call is received at the PSAP 120. At step 612, the contact is received, typically in a queue, and the audio and video capability of the contact may be sensed. For example, if the contact, or call, only has the capability to send audio, then at step 612, an audio-only call is sensed. If, on the other hand, the communication endpoint 112 is capable of providing both audio and video, then a multimedia call comprising audio and video may be sensed.

The method then proceeds to step 616 and 662 depending on the characteristics of the communication. For example, if the communication endpoint 112 associated with the call or contact from caller 104 is capable of providing both audio and video, and indeed initiates contact with the PSAP 120 with both audio and video, then both steps 616 and 662 would be performed. At step 616, the audio portion of the communication (e.g., the audio stream) may be split and/or separated from the communication information; the audio stream may be split into at least two separate audio streams by stream splitter 224 as previously described. Moreover, the stream splitter 224 may also split and/or separate the video stream at step 662 as previously described.

Method 600 then proceeds to steps 620 and 640 where a first instance of a received audio stream is filtered at step 620 and a second instance of a received audio stream is filtered at step 640. At step 620, the first instance of the audio stream may be filtered to isolate components of speech; for example, the auditory component analysis module 304 and/or the speech analysis module 308 may filter the first instance of the audio to stream to remove non-speech components that are not to be analyzed by speech analysis module 308; thus, only the speech components remain within the first instance of the audio stream. At step 624, the auditory component analysis module 304 and/or the speech analysis module 308 may extract speech components and specifically identify the speech components as such. That is, at step 624, speech may be converted into a word or syllable; the converted speech component may then be stored in the auditory signs database 324. Alternatively, or in addition, the speech components may be stored in the auditory signs database 324 as audio information, audio data, or raw audio data—such as an audio waveform. In some embodiments, at step 624 the auditory component analysis module 304 may separately identify each voice as being associated with one or more individuals. For example, voice fingerprinting may be used to separate and identify speech components; those speech components that are determined to be the clearest may then be analyzed using the speech analysis module 308. Alternatively, or in addition, all speech components detected, regardless of the individual to whom they belong, are analyzed at the speech analysis module 308.

At step 628, the separated speech components are then analyzed for clinical auditory signs. For instance, at step 628, the stored converted speech component or stored audio waveform may then be compared to speech information that may reside in the pattern analysis and sound library 316. For example, if one or more words and/or one or more phrases are repetitively present in the audio information received from a caller 104, the repetitive word may identified as an auditory clinical sign using one or more of the stored converted speech components and the stored audio waveforms. Alternatively, or in addition, step 628 may determine that the caller 104 is slurring one or more words and/or one or more phrases, as detected by one or more of the stored converted speech components and the stored audio waveforms. The results of the analysis step 628 are then provided to step 632, where one or more clinical signs are classified and/or assessed such that an action can be performed at step 636 based on the results of step 628 and 632. For example, if, at step 628, it is determined that the caller 104 exhibits one or more clinical signs related to repetitive word use or slurred speech, the clinical signs UI module 244 may be updated to reflect this at step 636. As one example, the sound area 444 may highlight a waveform containing the repetitive word. Alternatively, or in addition, the detected signs summary 428 may be updated to display this information.

At step 640, the second instance of the audio stream may be filtered to isolate components of non-speech; for example, the auditory component analysis module 304 and/or the non-speech analysis module 312 may filter the second instance of the audio to stream to remove speech components that are not to be analyzed by non-speech analysis module 312; thus, only the non-speech components remain within the second instance of the audio stream. At step 644, the auditory component analysis module 304 and/or the non-speech analysis module 312 may extract non-speech components. The non-speech components may then be separated at step 644 such that individual non-speech components may be stored in the auditory signs database 324. At step 648, the non-speech analysis module 312 may then determine breath information, such as but not limited to, one or more of a respiratory rate, an inhalation time, an exhalation time, a time between inhalation and exhalation, a time between exhalation and inhalation, a respiratory rhythm, quality, and any noises (such as crowing, crawing, wheezing, whistling, rattling, gurgling, snoring, stridor, and/or coughing) associated therewith. The non-speech analysis module may convert or characterize each detected non-speech component such that the non-speech component can be stored in the auditory signs database 324. The non-speech analysis module 312 may store breath information in an auditory signs database 324 and then compare or match the stored breath information to breath information contained in the pattern analysis & sound library 316. If any of the detected and stored breath information matches patterns or sounds determined to be of clinical significance (and previously stored in the pattern analysis & sound library 316), then at step 632, the breath sound is classified and/or assessed such that an action can be performed based on the results of the non-speech analysis step 648. For example, an indication that the caller 104 is exhibiting one or more clinical breath signs may be indicated to the clinical signs UI module 244 in step 636. Alternatively, or in addition, a whisper tone or other low-volume announcement may be provided to an agent 144 so as not to drown out the caller or anyone else who may be currently speaking.

In some instances, a caller 104 may be exhibiting clinical signs that involve both non-speech components and speech components. Thus, at step 632, the results of the non-speech component analysis in step 648 and the speech component analysis in step 628 may be determined. For example, at step 632, it may be determined as to whether or not a caller 104 is speaking in short, fragmented phrases or in single words. As another example, step 632 may operate to determine a respiratory rate while the caller 104 is talking; determine whether or not the speech sounds are more similar to known speech sounds, clinical breaths sounds, or a combination thereof. Additionally, step 632 may operate to determine whether the detected breathing sounds are more likely resulting from speech-related clinical signs, or if the detected speech-related clinical signs are more likely resulting from breath-related clinical signs. If any of the detected breath information and/or speech information is likely to be of clinical significance, then method 600 proceeds to step 636 where an action is performed, such as providing an indication to the clinical signs UI module 244 or providing a whisper tone to an agent 144.

Depending on the characteristics of the communication between the caller 104 and the PSAP 120, at step 662 the video portion of the communication (e.g., the video stream) may be split and/or separated from the communication information. At step 666, the video stream may be segmented such that visual component analysis module 328 may detect changes, measure the degree of change, localize the change, and extract relevant changes for further analysis and qualification. Moreover, at step 670, the clinical visual signs analysis module 232 may utilize video analytics and/or video content analysis algorithms, such as computer vision, pattern analysis, machine intelligence, and combinations thereof to detect, recognize, or otherwise sense clinical signs that are visual in nature. For example, the method of video analytics uses computer vision algorithms to enable it to perceive or see and machine intelligence to interpret, learn and draw inferences. Video analytics can understand a scene, which differs from motion detection. In addition to detecting motion, video analytics can qualify the motion as an object, understand the context around the object, and track the object through the scene. Commonly, video analytics detects changes occurring over successive frames of video, qualifies these changes in each frame, correlates qualified changes over multiple frames, and interprets these correlated changes.

At step 670, the clinical visual signs analysis module 232 may recognize clinical signs associated with a caller 104. At step 670, one or more clinically significant visual indicators associated with caller 104 may be detected, such as but not limited to, caller 104's skin color (a blue or purplish coloring of the skin or mucous membrane that indicative of cyanosis; a pale skin color; a reddish brown skin color); any frothy secretions near caller 104's lips; any chemical burns around caller 104's mouth; the skin moisture of caller 104; any signs of trauma (for instance, deformities, contusions, abrasions, punctures, penetrations, burns, lacerations, swelling); jugular vein distention; blood or cerebral spinal fluid leakage from the ears or nose; and/or asymmetric or dilated pupils. Upon detecting visual clinical signs, the method 600 proceeds from step 670 to step 632 where the visual clinical signs are assessed and/or classified. Based on the results of step 670 and that of 632, an action may be performed at step 636. The action may comprise providing an indication to the clinical signs UI module 244 or providing a whisper tone to an agent 144.

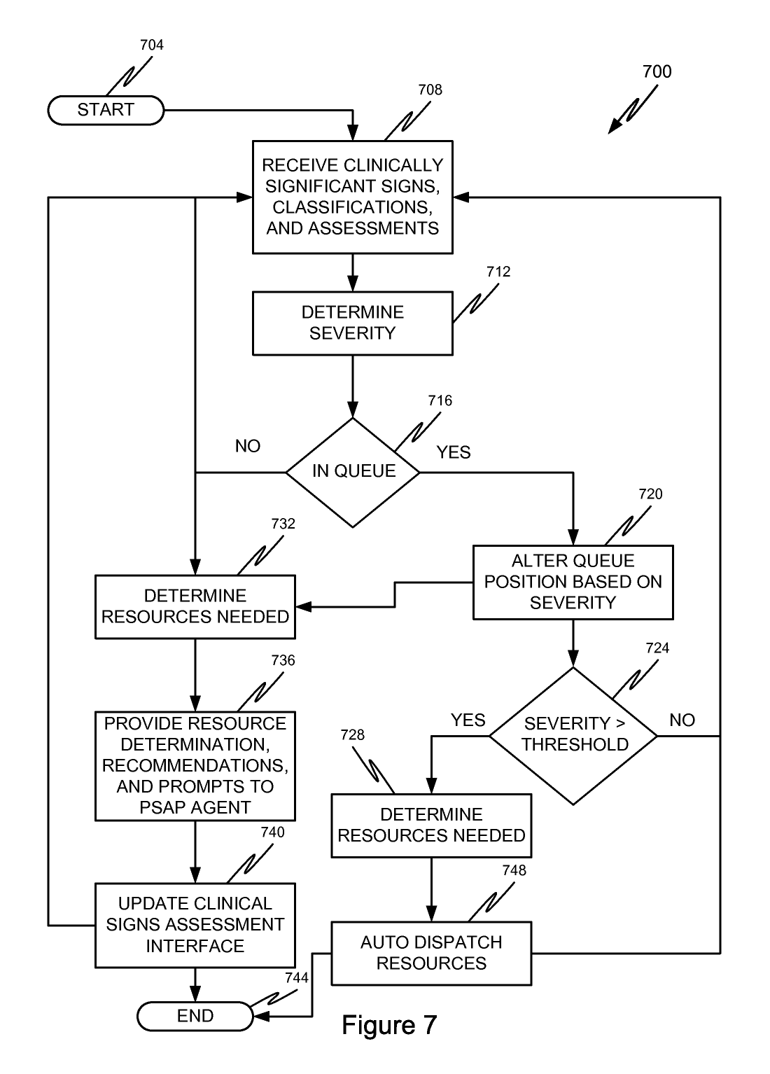

Referring now to FIG. 7, a method 700 is discussed in accordance with embodiments of the present disclosure. Method 700 is in embodiments, performed by a device, such as work assignment mechanism 124. More specifically, one or more hardware and software components may be involved in performing method 700. In one embodiment, one or more of the previously described modules perform one or more of the steps of method 700. The method 700 may be executed as a set of computer-executable instructions executed by a computer system and encoded or stored on a computer-readable medium. Hereinafter, the method 700 shall be explained with reference to systems, components, modules, software, etc. described with FIGS. 1-6.

Method 700 may continuously flow in a loop, flow according to a timed event, or flow according to a change in an operating or status parameter. Method 700 is initiated at step 704 wherein a visual or auditory clinical sign is provided to step 708. For example, step 708 may follow step 632 in method 600. Once the identified clinical signs are received at step 708, the work assignment mechanism 124 may task the clinical signs analysis module 152 with determining a severity or expected level of response to one or more detected clinical signs at step 712. For example, at step 712, the clinical auditory signs module 228 may detect that a caller 104 exhibits multiple ongoing instances of slurred speech. Additionally, the clinical visual signs module 232 may detect that a caller 104 appears to display a facial droop. In response to these two detected clinical signs, the clinical signs analysis module 152 may determine that the severity of caller 104's condition is medium-high. Thus, based on the clinical signs presented, a severity level may be assigned to a caller 104.

The severity level may be provided by any indication that is capable of providing a severity level. For example, the severity level may range from one to twenty, with twenty being the most severe and one being the least severe. Alternatively, or in addition, the severity level may range from green to yellow to orange to read, with green being the least severe and red being the most severe. If, at step 716, it is determined that the caller 104 is not in a queue, then the based on the detected clinical signs, the clinical signs analysis module 152 may determine that both a BLS and ALS response is needed in step 732. At step 736, the resource determination, guidance that may or may not be based on the Dispatch Guidecards, and prompts may be determined. At step 740, the clinical signs assessment interface is updated to reflect the determined resources, recommendations, guidance, and prompts. The process then ends at step 744 or the process then repeats at step 708.

If at step 716, it is determined that the caller 104 is in a queue, depending on a policy implemented at the PSAP 120, the caller 104's queue position may be altered based upon the severity determination in step 712. However, it should be noted that step 720 is an optional step and need not be followed if the PSAP 120 does not implement such a policy. It may be that step 720 is implemented in very specific operating scenarios. For example, a caller 104's queue position may be altered in response to a determined severity and a caller's location. Step 720 may then proceed to step 732.

If the caller remains in a queue and the severity is greater than one or more thresholds, such as in step 724, then at step 728, based on the detected clinical signs, the clinical signs analysis module 152 may determine that both a BLS and ALS response is needed in step 728 and resources may be automatically dispatched at step 748. The process may then end at step 744.

Alternatively, or in addition, the process may return to step 708 in instances where the caller's severity is not above a threshold or the appropriate resource require verification and confirmation prior to being auto dispatched.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method for automatically detecting clinical signs at a Public Safety Answering Point (PSAP), comprising:
receiving a contact initiated from a caller;
analyzing the contact to determine a contact characteristic;
based upon the contact characteristic, delivering call information associated with the contact to a clinical signs detection module;
automatically analyzing the call information and separately extracting one or more non-speech components from speech components;
automatically performing an analysis on the one or more non-speech components to determine a characteristic associated with the one or more non-speech components;
automatically comparing the characteristic associated with the one or more non-speech components to known characteristics associated with at least one clinical sign; and
providing, as a detected clinical sign associated with the contact, an indication of the at least one clinical sign to at least one workstation associated with a PSAP agent.

2. (canceled)

3. The method of claim 1, further comprising:
determining whether the one or more non-speech components are associated with breath sounds; and
measuring a respiratory rate based on the non-speech components that are associated with breath sounds.

4. The method of claim 1, further comprising:
automatically analyzing the call information for one or more speech components;
automatically performing an analysis on the one or more speech components to determine a characteristic associated with the one or more speech components; and
determining whether the characteristic associated with the one or more speech components matches known characteristics associated with at least one clinical sign.

5. The method of claim 4, further comprising:
converting the one or more speech components into one or more words; and
performing a contextual analysis on the one or more words to determine at least one of (i) the caller repeats one or more words; (ii) one or more words spoken by the caller are contextually in the wrong order; (iii) one or more words are slurred; and (iv) the caller speaks in short, fragmented phrases.

6. The method of claim 4, further comprising:
analyzing the call information for one or more portions of video; and
performing an analysis on the one or more portions of video to detect one or more visual clinical signs.

7. The method of claim 6, further comprising:
determining whether a pupil associated with the contact varies with respect to one or more of size and reactivity.

8. The method of claim 6, further comprising:
indicating on a workstation of a PSAP agent, the one or more visual clinical signs.

9. The method of claim 1, wherein the detected clinical sign associated with the contact is for a caller other than the caller that initiated the contact.

10. The method of claim 1, further comprising
dispatching resources based on the detected clinical sign associated with the contact; and
providing the dispatched resources the detected clinical sign associated with the contact.

11. The method of claim 1, wherein the analyzing further comprises:
analyzing a portion of the call information to detect a change in the detected clinical sign associated with the contact, wherein the change is associated with one or more of a pattern and a trend.

12. A non-transitory computer readable information storage medium having stored thereon instructions that cause a computing system to execute a method of automatically detecting clinical signs at a Public Safety Answering Point (PSAP) comprising:
receiving a contact initiated from a caller;
analyzing the contact to determine a contact characteristic;
based upon the contact characteristic, delivering call information associated with the contact to a clinical signs detection module;
automatically analyzing the call information and separately extracting one or more non-speech components from speech components;
automatically performing an analysis on the one or more non-speech components to determine a characteristic associated with the one or more non-speech components;
automatically comparing the characteristic associated with the one or more non-speech components to known characteristics associated with at least one clinical sign; and
providing an indication of the at least one clinical sign to at least one workstation associated with a PSAP agent.

13. The non-transitory computer-readable medium of claim 12, wherein the instructions further comprise:
determining whether the one or more non-speech components are associated with breath sounds.

14. The non-transitory computer-readable medium of claim 12, wherein the instructions further comprise:
analyzing the call information for one or more speech components;
performing an analysis on the one or more speech components to determine a characteristic associated with the one or more speech components; and
determining whether the characteristic associated with the one or more speech components matches known characteristics associated with at least one clinical sign.

15. The non-transitory computer-readable medium of claim 14, wherein the instructions further comprise:
converting the one or more speech components into one or more words; and
performing a contextual analysis on the one or more words to determine at least one of (i) the caller repeats one or more words; (ii) one or more words spoken by the caller are contextually in the wrong order; (iii) one or more words are slurred; and (iv) the caller speaks in short, fragmented phrases.

16. The non-transitory computer-readable medium of claim 12, wherein the instructions further comprise:
analyzing the call information for one or more portions of video; and
performing an analysis on the one or more portions of video to detect one or more visual clinical signs.

17. A system that facilitates automatically detecting clinical signs at a Public Safety Answering Point (PSAP), comprising:
a workstation that receives a contact initiated from a caller;
a clinical signs analysis module configured to analyze the contact to determine a contact characteristic and based upon the contact characteristic, and deliver call information associated with the contact to a clinical signs detection module, wherein one or more modules of the clinical signs detection module are configured to automatically analyze the call information and separately extracts one or more non-speech components from speech components, automatically perform an analysis on the one or more non-speech components to determine a characteristic associated with the one or more non-speech components, and automatically compare the characteristic associated with the one or more non-speech components to known characteristics associated with at least one clinical sign, wherein the clinical signs analysis module is further configured to provide an indication of the at least one clinical sign to at least one workstation associated with a PSAP agent.

18. (canceled)

19. The system of claim 17, further comprising one or more modules configured to determine whether the one or more non-speech components are associated with breath sounds.

20. The system of claim 17, further comprising one or more modules configured to:
analyze the call information for one or more speech components;
perform an analysis on the one or more speech components to determine a characteristic associated with the one or more speech components; and
determine whether or not the characteristic associated with the one or more speech components matches known characteristics associated with at least one clinical sign.

21. The system of claim 17, further comprising one or more modules configured to:
analyze the call information for one or more portions of video; and
perform an analysis on the one or more portions of video to detect one or more visual clinical signs.
